(19) United States
(12) Patent Application Publication
(10) Pub. No.: US 2001/0040427 A1
(43) Pub. Date: Nov. 15, 2001

(54) Deflection unit for color cathode ray tubes

(75) Inventor: Friedrich-Karl Nelle, Stuttgart (DE)

Correspondence Address: BOYLE FREDRICKSON NEWHOLM STEIN & GRATZ, SUITE 1030, 250 EAST WISCONSIN AVENUE, MILWAUKEE, WI, 53202, US

(73) Assignee: Matsushita Display Devices (Germany) GmbH

(21) Appl. No.: 09/821,746

(22) Filed: Mar. 29, 2001

(30) Foreign Application Priority Data
Mar. 29, 2000 (EP) 00106713.1

(51) Int. Cl. H01J 29/64

(52) U.S. Cl. 313/442

(57) ABSTRACT

The present invention refers to a deflection unit for mounting on a color cathode ray tube, an associated tube and a corresponding display apparatus. The deflection unit comprises a pair of coils for vertical deflection and a pair of coils for horizontal deflection. At least one of the pair of coils is subdivided into at least two parts, of which one part is intended for the correction of convergence errors and the other part for the correction of geometry errors. The respective corrections can be carried out independently of the respectively other correction. According to a preferred embodiment the parts are spatially separated and mechanically independent, with the part intended for geometry error correction being positioned closer to the screen of the picture tube. Preferred is the use of an in-line type arrangement of the saddle-saddle or saddle-toroidal type.

The present invention relates in general to a deflection unit for mounting on a color cathode ray tube and is in particular concerned with the correction of convergence errors and geometry errors in such a deflection unit.

Deflection units are mounted on a cathode ray tube to deflect the electron beams across the screen in X- and Y-direction. The deflection unit consists essentially of two pairs of coils and a ferrite core for returning the magnetic flux. The one pair of coils produces a magnetic field which deflects the electron beams in horizontal direction (X-direction) whereas the other pair of coils serves vertical deflection (Y-direction).

A constructional form often used for modern color picture tubes is the in-line type arrangement in which the beam generating systems are arranged in one plane side by side. In such systems three electron beams are generated whose axes extend in coplanar fashion and which converge on the screen. The picture produced by deflection units suited for this type of color picture tubes is self-converging, coma-free and essentially without any north-south raster distortions. This is essentially achieved by a field shape varying in the Z-direction. The Z-direction is here the axis extending towards the screen.

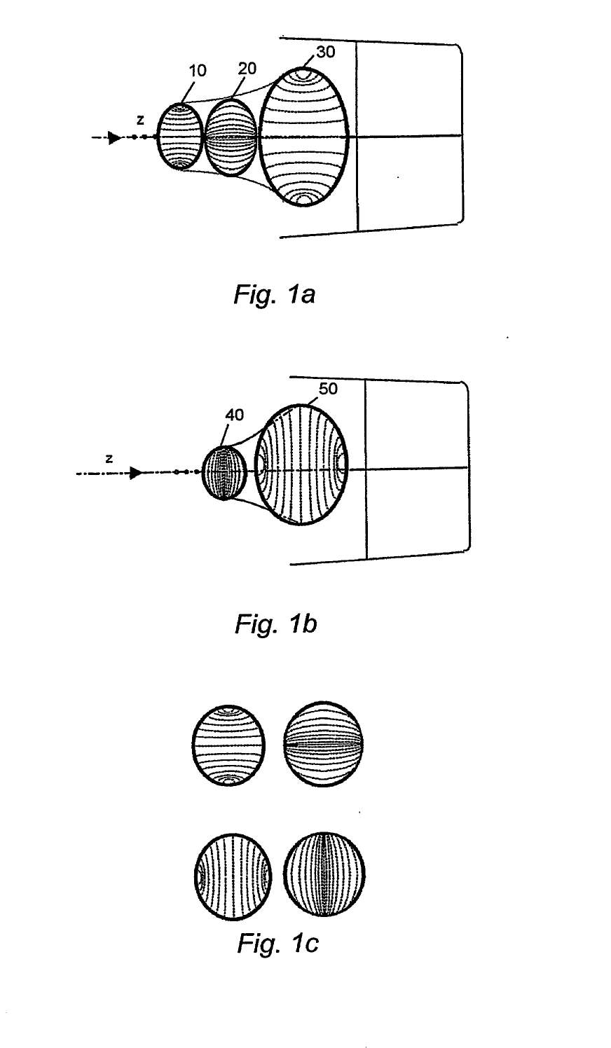

FIGS. 1a and 1b illustrate the deflection fields for the vertical and horizontal deflection direction in a deflection unit for in-line type color picture tubes. As can be seen in the figures, the field distributions in the rear portions 10, 40 of the deflection unit differ from those of the central portion 20 and the front portion 30, 50 of the deflection unit.

The field shapes which can be employed for use in such deflection units are shown in FIG. 1c, the left field distributions being pincushion-shaped and the right ones barrel-shaped. The upper field distributions shown in FIG. 1c are used for the vertical deflection direction whereas the lower field distributions are employed for horizontal deflection.

As can be learnt from FIG. 1a, a pincushion-shaped deflection field is used for the vertical deflection direction in the rear portion of the deflection unit, a barrel-shaped deflection field is used in the central portion, and a pincushion-shaped deflection field is again used in the front portion. For the horizontal deflection direction the deflection unit as shown in FIG. 1b comprises a barrel-shaped deflection field in the rear portion and a pincushion-shaped deflection field in the front portion. As described above, a self-converging picture which is free of coma errors and north-south raster distortions is obtained through said arrangements.

Essentially two types of errors may arise due to construction errors in the picture tubes and deflection units: convergence errors and geometry errors. Convergence errors are observed whenever the primary color images have no congruent rasters any more. By contrast, geometry errors arise whenever the raster image is shown in distorted form on the screen. Convergence and geometry errors may also occur at the same time.

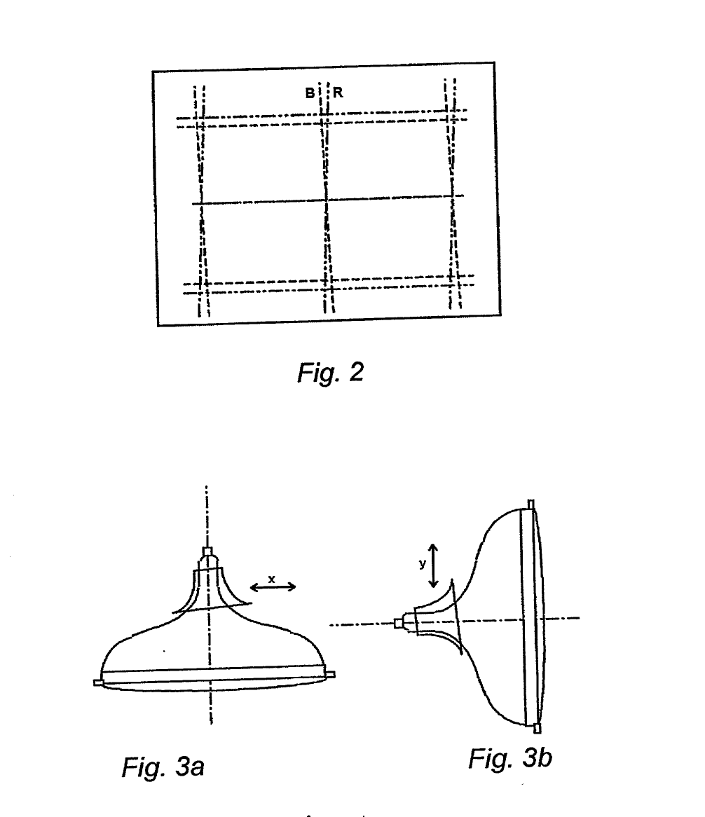

An example of the presence of convergence errors is shown in FIG. 2 where due to construction tolerances the blue beam can no longer be made congruent with the read beam. For the correction of such a convergence error the deflection unit is normally tilted in conventional assemblies, as shown in FIGS. 3a and 3b for the X-direction and Y-direction, respectively.

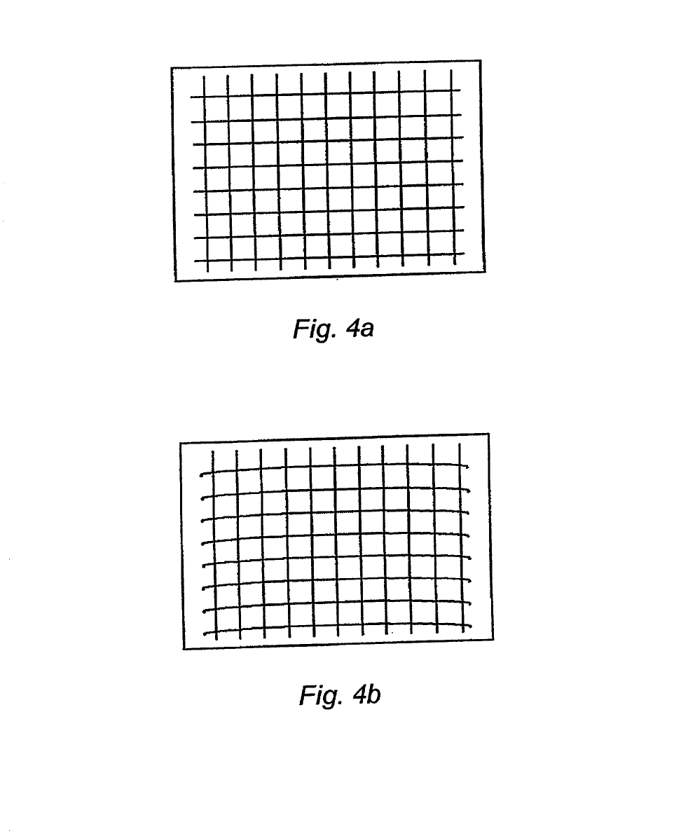

Such an error correction has the drawback that undesired asymmetrical geometry errors may be produced because of the inhomogeneous fields in the front portion of the deflection unit. This is further illustrated with reference to FIGS. 4a and 4b. FIG. 4a shows an ideal raster and FIG. 4b a distorted raster created by tilting the deflection unit in the Y-direction.

Another prior-art correction device for coma errors created by the difference in the raster dimensions of the three electron beams in the in-line type, which is due to the eccentric position of the outer in-line guns, based on the horizontal and vertical deflection fields, comprises an additional pair of coils which are mechanically fixed onto the rear side of the deflection unit. This pair of coils permits a correction of the convergence error by means of suitable circuitry measures. Although the additional pair of coils allows convergence corrections without substantially affecting the geometry, the circuitry measures required therefore are very complicated.

It is therefore the object of the present invention to provide a simplified deflection unit for mounting on a color cathode ray tube which permits an improved convergence and geometry error correction. Another object of the invention consists in providing associated color cathode ray tubes and display apparatuses.

According to the invention a deflection unit for mounting on a color cathode ray tube comprises a pair of coils for vertical deflection and a pair of coils for horizontal deflection, with at least one of the pairs of coils being divided into at least two parts. One part serves the correction of convergence errors and the other part the correction of geometry errors. The respective corrections can be made independently of the respectively other correction.

This arrangement according to the invention has the advantage that it permits a convergence correction without producing a considerable geometry error.

Moreover, thanks to the separate adjustment of the two types of errors, highly sensitive deflection units can be realized, in particular, also with respect to a correction of the coma error.

In preferred embodiments the two parts are mechanically independent and spatially separated from each other, the part intended for the correction of the geometry errors being positioned closer to the screen plane than the part intended for the correction of the convergence errors.

To obtain different correction characteristics it is here possible to subdivide either only the pair of coils for vertical deflection or only the pair of coils for horizontal deflection or both pairs of coils.

Preferred embodiments are defined in the subclaims.

The invention shall now be explained with reference to the attached drawings, in which:

FIG. 1a shows the field shape of the deflection field that is variable in the Z-direction, for the vertical deflection direction;

FIG. 1b shows the field shape of the deflection field that is variable in the 7-direction, for the horizontal deflection direction;

FIG. 1c illustrates the pincushion-shaped and barrel-shaped deflection fields in the horizontal and vertical deflection direction;

FIG. 2 is an illustration of a convergence error created by construction tolerances in the picture tube and the deflection unit;

FIGS. 3a illustrate the conventional tilt correction of convergence errors in the and FIG. 3b X and Y-direction;

FIG. 4a is an illustration of the ideal raster;

FIG. 4b is an illustration of a raster with asymmetrical geometry errors by tilting the deflection unit in the Y-direction;

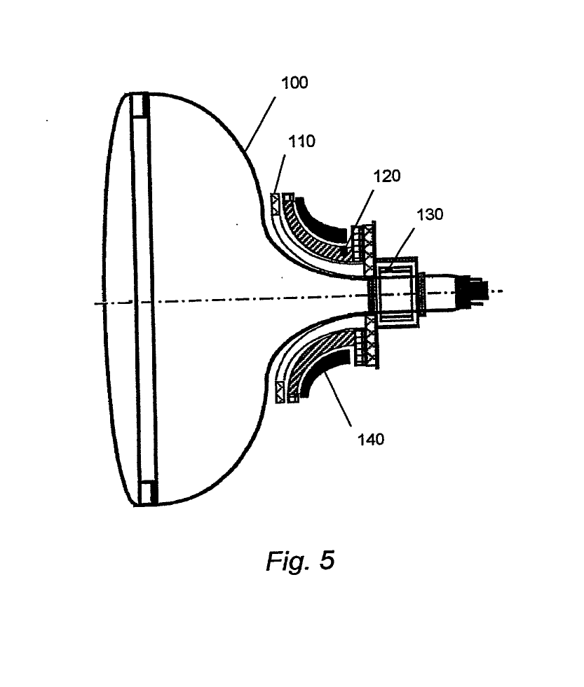

FIG. 5 shows an embodiment of a deflection unit mounted on a color cathode ray tube, in a sectional view;

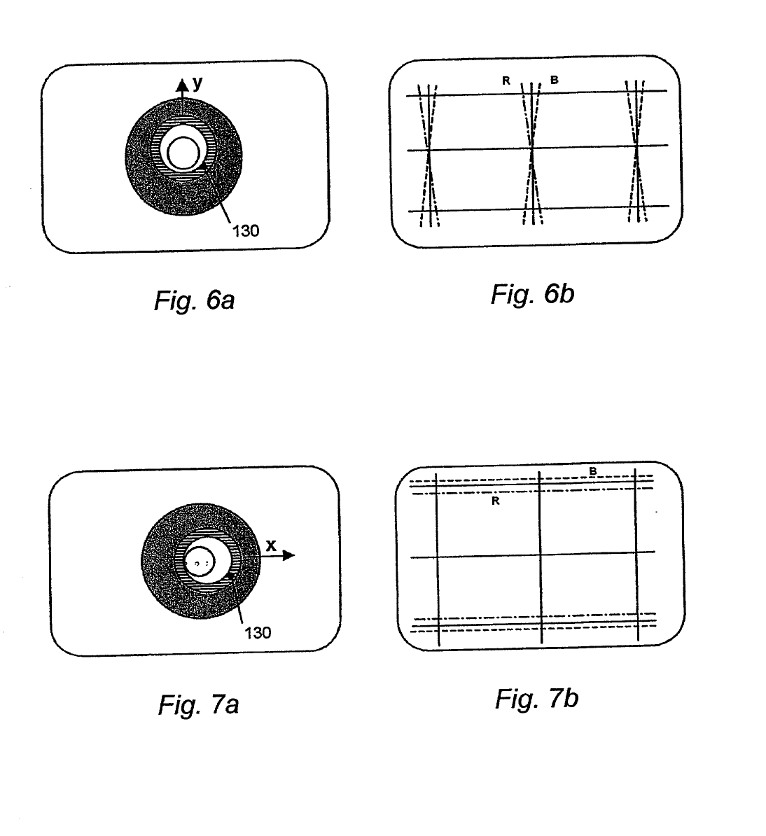

FIG. 6a is a sectional illustration with view in the Z-direction for illustrating the convergence error correction by way of a Y-movement;

FIG. 6b is an illustration of the convergence error which can be corrected by the arrangement of FIG. 6a;

FIG. 7a shows an arrangement, corresponding to the illustration of FIG. 6a, for a correction in the X-direction; and

FIG. 7b illustrates the convergence error which can be corrected by said arrangement.

With reference to the figures, preferred embodiments of the invention shall now be explained in more detail.

FIG. 5 shows a color cathode ray tube with mounted-on deflection unit in a sectional view. The deflection unit mounted on the neck of the color picture tube 100 first comprises a horizontal coil 110, a vertical coil 120, 130, and a ferrite core 140. As can be seen in the figure, the vertical coil is divided into a front coil part 120 and a rear coil part 130. A geometry error can be corrected and adjusted by means of the front coil part 120. The rear coil part 130 permits the independent correction of convergence errors, such as a coma error.

The convergence error correction by the arrangement shown in FIG. 5 shall now be explained in more detail with reference to FIGS. 6 and 7. FIG. 6a shows a vertical coil 130 displaced in the Y-direction, whereby the convergence errors shown in FIG. 6b can be corrected without producing geometry errors. In the arrangement shown in FIG. 7a, the rear vertical coil part 130 is displaced in X-direction, which permits the correction of another convergence error illustrated in FIG. 7b.

Although in the described embodiment the pair of vertical coils is subdivided, the pair of horizontal coils can be subdivided in another embodiment of the invention. In a further preferred embodiment of the invention the two pairs of coils are subdivided, resulting in different correction characteristics.

In a further preferred embodiment the respective pair of coils is not only divided into two parts. Rather, a further improved error correction and convergence or geometry adjustment can be achieved in a preferred manner by subdivision into three or more parts.

The invention can preferably be employed in saddle-saddle deflection units, but also in saddle-toroidal deflection units. Preferably, the invention is employed in “pure-flat” type color picture tubes.

1. A deflection unit for mounting on a color cathode ray tube (100), comprising:
a pair of coils (120, 130) for vertical deflection, and
a pair of coils (110) for horizontal deflection,
wherein at least one of the pairs of coils is subdivided into at least two parts, of which one part is intended for correcting convergence errors and the other part for correcting geometry errors, and
wherein the respective corrections can be carried out independently of the respectively other correction.

2. The deflection unit according to claim 1, wherein the at least two parts are spatially separated and arranged to be mechanically independent of each other and the part intended for the correction of geometry errors is positioned closer to the screen of the color cathode ray tube than the pal intended for the correction of convergence errors.

3. The deflection unit according to claim 1 or 2, wherein the subdivided pair of coils is the pair of coils for horizontal deflection.

4. The deflection unit according to claim 1 or 2, wherein the subdivided pair of coils is the pair of coils for vertical deflection.

5. The deflection unit according to any one of claims 1 to 4, further comprising means for the fine adjustment of the convergence error correction and/or the geometry error correction.

6. The deflection unit according to any one of claims 1 to 5, equipped for use with an in-line type color picture tube.

7. The deflection unit according to any one of claims 1 to 6, wherein the deflection unit is a saddle-toroidal deflection unit.

8. The deflection unit according to any one of claims 1 to 6, wherein the deflection unit is a saddle-saddle deflection unit.

9. A color cathode ray tube comprising a deflection unit according to any one of claims 1 to 8.

10. A display apparatus comprising a color cathode ray tube (100) and a deflection unit according to any one of claims 1 to 8.
